(19) United States
(12) Patent Application Publication
(10) Pub. No.: US 2018/0282650 A1
(43) Pub. Date: Oct. 4, 2018

(54) Dust-resistant sliding member and method for producing same, window regulator carrier plate, and method for realizing dust-resistant slidability

(71) Applicant: Polyplastics Co., Ltd., Tokyo (JP)

(72) Inventors: Yuki Kanda, Fuji-shi (JP); Tomohiro Monma, Fuji-shi (JP); Takanori Ueda, Farmington Hills, MI (US)

(73) Assignee: Polyplastics Co., Ltd., Tokyo (JP)

(21) Appl. No.: 15/475,522

(22) Filed: Mar. 31, 2017

(51) Int. Cl. C10M 107/50; C08L 59/04; C10M 107/06; C10M 125/30; C10M 125/28; C10M 107/34; B60J 1/16

(52) U.S. Cl. CPC C10M 107/50; B60J 1/17; C10M 107/06; C10M 125/30; C10M 125/28; C10M 107/34; B60J 1/16; C10M 2205/0245; C10M 2229/041; C10M 2203/022; C10M 2201/062; C10M 2201/12; C10M 2201/103; C10M 2209/1085; C08L 59/04

(57) ABSTRACT

A method for producing a dust-resistant sliding member, the method including a step of preparing a resin composition containing 0.5 to 5.0 parts by mass of a lubricant that is liquid at 25° C. and is composed of at least one material selected from the group consisting of ethylene/α-olefin copolymers, poly-α-olefins and silicones, and 0.1 to 30 parts by mass of an inorganic filler, per 100 parts by mass of a polyacetal resin, and a step of molding the resin composition into a prescribed shape.

### BACKGROUND

### Technical Field

The present invention relates to a dust-resistant sliding member that uses a polyacetal resin and a method for producing the same, and also relates to a window regulator carrier plate, and a method for realizing dust-resistant slidability for a member produced using a polyacetal resin composition.

### Related Art

Polyacetal resins (hereafter also referred to as “POM resins”) exhibit a variety of excellent physical and mechanical properties, and are therefore widely used as engineering plastics in many applications. In particular, because POM resins exhibit excellent sliding properties, they are often used as sliding members such as bearings and gear components (P2016-169344A).

The mechanism for raising and lowering the door glass in an automobile is called a window regulator. A window regulator has a carrier plate that supports the door glass, a guide rail that supports the carrier plate in a manner that enables up and down movement of the carrier plate, and a drive portion that raises and lowers the carrier plate along the guide rail. In this mechanism, when the door glass is being raised and lowered, because the carrier plate slides in a state supported by the guide rail, a material having excellent slidability must be used for the sliding portion, and a molded member formed using a polyacetal resin has typically been used.

Because this type of molded member is formed using a polyacetal resin having excellent sliding properties, it exhibits a consistent effect in terms of slidability. However, when dust such as sand and moisture such as rainwater penetrates inside the door, the same thinking cannot be applied. In other words, under these types of conditions, if up and down movement occurs with the members rubbing against one mother, then various problems can arise, including the occurrence of abnormal noises known as squeak noises, and an increase in the amount of abrasion. The problem of squeak noises is particularly noticeable in semi-dry states.

It has typically been thought that, even under these types of conditions, abnormal noises could be suppressed and good friction and wear resistance could be achieved by applying a grease to the sliding portion. However, recent developments have tended to focus on methods for addressing the above problems without using grease. For example, a method has been proposed in which the window regulator is produced using a special grade of polyacetal resin for just the sliding portion, and using a standard grade polyacetal resin for the remaining portions. However, differentiating the materials for the sliding portion and the remaining portions raises other problems, including an increase in the workload required to assemble the mechanism, and an increase in costs. Accordingly, it is desirable that the type of molded member described above is produced using a single POM resin composition.

Objects of the present invention are to provide a dust-resistant sliding member which, even in an environment in which dust such as sand and moisture exist, exhibits excellent friction and wear resistance and suffers little abnormal noise generation during sliding, and also to provide a method for producing the dust-resistant sliding member, a window regulator carrier plate, and a method for realizing dust-resistant slidability.

### SUMMARY

A method for producing a dust-resistant sliding member according to the present invention includes:

a step of preparing a resin composition containing 0.5 to 5.0 parts by mass of a lubricant that is liquid at 25° C. and is composed of at least one material selected from the group consisting of ethylene/α-olefin copolymers, poly-α-olefins and silicones, and 0.1 to 30 parts by mass of an inorganic filler, per 100 parts by mass of a polyacetal resin, and

a step of molding the resin composition into a prescribed shape.

The lubricant is preferably an ethylene-propylene copolymer.

The inorganic filler is preferably at least one material selected from the group consisting of calcium carbonate, magnesium oxide, aluminum oxide, talc and glass beads.

A dust-resistant sliding member of the present invention is produced using the method for producing a resin composition for a dust-resistant sliding member according to the present invention described above.

A window regulator carrier plate of the present invention is produced using the method for producing a resin composition for a dust-resistant sliding member according to the present invention described above.

A method for realizing dust-resistant slidability for a member produced using a polyacetal resin composition according to the present invention uses a resin composition containing 0.5 to 5.0 parts by mass of a lubricant that is liquid at 25° C. and is composed of at least one material selected from the group consisting of ethylene/α-olefin copolymers, poly-α-olefins and silicones, and 0.1 to 30 parts by mass of an inorganic filler, per 100 parts by mass of a polyacetal resin.

The present invention is able to provide a dust-resistant sliding member which, even in an environment in which dust such as sand and moisture exist, exhibits excellent friction and wear resistance and suffers little abnormal noise generation during sliding, as well as providing a method for producing the dust-resistant sliding member, a window regulator carrier plate, and a method for realizing dust-resistant slidability.

### DETAILED DESCRIPTION

### <Resin Composition for Dust-Resistant Sliding Member>

A resin composition for a dust-resistant sliding member according to an embodiment of the present invention (hereafter also referred to as simply “the resin composition”) contains 0.5 to 5.0 parts by mass of a lubricant that is liquid at 25° C. and is composed of at least one material selected from the group consisting of ethylene/α-olefin copolymers, poly-α-olefins and silicones, and 0.1 to 30 parts by mass of an inorganic filler, per 100 parts by mass of a polyacetal resin.

Here, the expression “dust-resistant sliding” refers to performance that exhibits excellent friction and wear resistance and good suppression of abnormal noise generation, even in environments in which dust such as sand and moisture such as rainwater exist. The expression “friction and wear resistance” means having good durability relative to friction and abrasion.

As mentioned above, the resin composition for a dust-resistant sliding member according to this embodiment has the effects of providing excellent friction and wear resistance and little abnormal noise generation during sliding, even in environments in which dust such as sand and moisture exist. The mechanism of those effects is described below.

Polyacetal resins are prone to the generation of abnormal noises known as squeak noises when sliding occurs between polyacetal resin members. In order to ameliorate this problem, a technique is used in which a lubricant is added to prevent sliding between the polyacetal resin members. However, in the above type of environments where dust and moisture exist, the occurrence of abnormal noises is unable to be satisfactorily suppressed using this technique. One reason for this is that when sliding occurs at the sliding surface of a resin molded item, the heat generated by sliding increases the temperature, but if moisture is present, then the temperature is less likely to rise. Accordingly, in the case where a solid lubricant is used, the solid lubricant is less likely to undergo a phase change to a liquid, meaning the inherent functionality of the lubricant is less likely to manifest. Moreover, if dust such as sand exists on the sliding surface, then the generation of wear debris tends to be accelerated by the dust. As a result, a sliding state between polyacetal resin members develops between the resin molded article and the wear debris, under conditions in which the lubricant is unable to function efficiently, leading to the occurrence of squeak noises.

Accordingly, the present embodiment uses a specific lubricant that is a liquid at 25° C., meaning the inherent functionality of the lubricant can manifest even in environments in which moisture exists. However, investigations by the inventors of the present invention revealed that the generation of abnormal noises could not be satisfactorily suppressed simply be using this lubricant. It is thought that this is because, in the presence of dust, localized increases in surface pressure occur on the sliding surface. Accordingly, an inorganic filler is also used to suppress this type of localized increase in surface pressure, thereby suppressing the occurrence of abnormal noises.

Each of the components of the resin composition according to the present embodiment is described below.

### [Polyacetal Resin]

The polyacetal resin is a polymer compound containing oxymethylene groups (—CH₂O—) as the main structural unit, and may be either a polyoxymethylene homopolymer or an oxymethylene copolymer. An oxymethylene copolymer contains oxymethylene groups as the main repeating unit, and also contains a small amount of one or more other structural units such as comonomer units of ethylene oxide, 1,3-dioxolane, or 1,4-butanediol formal or the like. Further, other types of polymers such as terpolymers and block polymers also exist, and these types of polymers may also be used. Furthermore, the polyacetal resin is not limited to linear molecules, and may include molecules having branched or crosslinked structures. Conventional modified polyoxymethylenes containing other introduced organic groups may also be used. There are no particular limitations on the polymerization degree of the polyacetal resin, and any resin having melt molding processability may be used (for example, resins having a melt flow rate (MFR) at 190° C. and a load of 2,160 g of at least 1.0 g/10 min but not more than 100 g/10 min).

The polyacetal resin may be produced using known production methods.

### [Lubricant]

The lubricant used in the present embodiment is at least one material selected from the group consisting of ethylene/α-olefin copolymers, poly-α-olefins and silicones, and is a liquid at 25° C. Because the lubricant is a liquid at 25° C., it remains a liquid even in environments containing moisture where the temperature is less likely to rise, and can therefore still function satisfactorily as a lubricant.

Examples of the ethylene/α-olefin copolymers include copolymers of ethylene and α-olefins having a carbon number of 3 to 20, For example, ethylene-propylene copolymers, ethylene-butylene copolymers and ethylene-hexene copolymers are preferred, and of these, ethylene-propylene copolymers are particularly preferred.

Examples of the poly-α-olefins include polymers of α-olefins having a carbon number of 6 to 18, and of these, polymers of α-olefins having a carbon number of 10 to 16 are preferred.

Examples of the silicones include dimethylpolysiloxanes, methylphenylpolysiloxanes and methylhydrogenpolysiloxanes, and of these, dimethylpolysiloxanes are preferred.

Any of the ethylene/α-olefin copolymers, poly-α-olefins and silicones may be used individually, or a combination of materials may be used. Further, among ethylene/α-olefin copolymers, poly-α-olefins and silicones, in terms of suppressing squeak noises, ethylene/α-olefin copolymers are preferred.

The lubricant is included in an amount of 0.5 to 5.0 parts by mass per 100 parts by mass of the polyacetal resin. If the amount of the lubricant is less than 0.5 parts by mass, then the occurrence of squeak noises cannot be satisfactorily suppressed, whereas if the amount exceeds 5.0 parts by mass, the manufacturability deteriorates markedly. The amount of the lubricant is preferably from, 0.8 to 4.0 parts by mass, and more preferably from 1.0 to 2.0 parts by mass.

### [Inorganic Filler]

Examples of inorganic fillers that may be used in the present embodiment include metal carbonates, metal sulfates, metal oxides, talc, mica, glass beads and glass flakes. Of these, calcium carbonate, magnesium oxide, aluminum oxide, talc and glass beads are preferred. These inorganic fillers may be used individually, or a combination of two or more different inorganic fillers may be used.

In the present embodiment, the inorganic filler is included in an amount of 0.1 to 30 parts by mass per 100 parts by mass of the polyacetal resin. If the amount of the inorganic filler is less than 0.1 parts by mass, then the occurrence of squeak noises cannot be satisfactorily suppressed, whereas if the amount exceeds 30 parts by mass, then deterioration in the mechanical properties becomes marked. The amount of the inorganic filler is preferably from 0.2 to 20 parts by mass, and more preferably from 0.3 to 10 parts by mass.

In the present embodiment, the mass ratio (X/Y) between the lubricant (X) and the inorganic filler (Y) is preferably from 1.5 to 5.0.

### [Other Components]

The resin composition of the present embodiment may also include conventional additives such as antioxidants, costabilizers, and compatibilizers as other components.

### <Dust-Resistant Sliding Member>

A dust-resistant sliding member according to one embodiment of the present invention is produced using the resin composition for a dust-resistant sliding member described above. As mentioned above, the dust-resistant sliding member according to this embodiment is a member that exhibits excellent friction and wear resistance and suffers little abnormal noise generation during sliding, even in environments in which dust such as sand and moisture exist.

Specific examples of the dust-resistant sliding member obtained by molding the resin composition according to an embodiment of the present invention include not only the window regulator carrier plate described below, but also sliding members for vehicle sunroofs, and mechanism members for vehicle door checkers. In other words, the dust-resistant sliding member is ideal as a member used in environments in which dust and water exist.

### <Window Regulator Carrier Plate>

A window regulator carrier plate according to one embodiment of the present invention is produced using the resin composition for a dust-resistant sliding member, in a similar manner to that described above for the dust-resistant sliding member. As mentioned above, a window regulator is a mechanism for raising and lowering the door glass of an automobile, and the carrier plate that supports the door glass is produced using the resin composition according to an embodiment of the present invention. Dust such as sand and moisture such as rainwater can sometimes penetrate into the interior of doors of vehicles such as automobiles. However, even in these types of cases, if the carrier plate of the present embodiment is installed, then the carrier plate exhibits excellent friction and wear resistance, and the generation of abnormal noises such as squeak noises when the window is raised and lowered, namely when the carrier plate undergoes sliding, can be suppressed.

### <Method for Producing Dust-Resistant Sliding Member>

A method for producing a dust-resistant sliding member according to an embodiment of the present invention includes a step (hereafter referred to as “step A”) of preparing a resin composition containing 0.5 to 5.0 parts by mass of a lubricant that is liquid at 25° C. and is composed of at least one material selected from the group consisting of ethylene/α-olefin copolymers, poly-α-olefins and silicones, and 0.1 to 30 parts by mass of an inorganic filler, per 100 parts by mass of a polyacetal resin, and a step (hereafter referred to as “step B”) of molding the resin composition into a prescribed shape. Each step is described below.

### [Step A]

In this step, a resin composition is prepared that contains 0.5 to 5.0 parts by mass of a lubricant that is liquid at 25° C. and is composed of at least one material selected from the group consisting of ethylene/α-olefin copolymers, poly-α-olefins and silicones, and 0.1 to 30 parts by mass of an inorganic filler, per 100 parts by mass of a polyacetal resin. Examples of preferred materials for each of the components, preferred amounts for each of the components, and examples of other components that may be used are all the same as described above. The resin composition can be obtained by normal methods, by mixing each of the above components and any other components that may be used as required. For example, the resin composition of the present embodiment can be obtained by supplying the components to an extruder, and performing melt-kneading and pelletization.

### [Step B]

In this step, the resin composition prepared in the above step A is molded into a prescribed shape. For example, the pellets obtained in the manner described above may be subjected to injection molding by introduction into an injection molding machine having a prescribed mold.

The production method of the present embodiment described above is able to produce a dust-resistant sliding member which, as mentioned above, exhibits excellent friction and wear resistance and suffers little abnormal noise generation during sliding, even in environments in which dust such as sand and moisture exist.

### <Method for Realizing Dust-Resistant Slidability>

A method for realizing dust-resistant slidability according to one embodiment of the present invention uses the resin composition containing 0.5 to 5.0 parts by mass of a lubricant that is liquid at 25° C. and is composed of at least one material selected from the group consisting of ethylene/α-olefin copolymers, poly-α-olefins and silicones, and 0.1 to 30 parts by mass of an inorganic filler, per 100 parts by mass of a polyacetal resin.

As mentioned above, a member obtained by molding this resin composition exhibits excellent friction and wear resistance and suffers little abnormal noise generation during sliding, even in environments in which dust such as sand and moisture exist. In other words, by using the resin composition of an embodiment of the present invention, a member formed using the polyacetal resin composition can be imparted with dust-resistant slidability.

### EXAMPLES

The present invention is described below in further detail based on a series of examples, but the present invention is in no way limited by these examples.

### Examples 1 to 10, Comparative Examples 1 to 5

In each example and comparative example, the raw material components shown in Table 1 or Table 2 were dry-blended, and the resulting mixture was introduced into a twin-screw extruder having a cylinder temperature of 200° C., subjected to melt-kneading, and then pelletized. In Table 1 and Table 2, the numerical value for each component indicates a number of parts by mass.

Details regarding each of the raw material components used are listed below.

Polyacetal resin: a polyacetal copolymer obtained by copolymerizing 96.7% by mass of trioxane and 3.3% by mass of 1,3-dioxolane (melt index (measured at 190° C. and a load of 2,160 g): 2.5 g/10 min)

Lubricant 1: an ethylene-propylene copolymer (pour point: −15° C., LUCANT HC600, manufactured by Mitsui Chemicals, Inc.)

Lubricant 2: a dimethylpolysiloxane (pour point: −41° C., SH200, manufactured by Dow Corning Toray Co., Ltd.)

Lubricant 3: a paraffin oil (pour point: −15° C., Diana Process Oil PW380, manufactured by Idemitsu Kosan Co., Ltd.)

Inorganic filler 1: calcium carbonate (SL-101, manufactured by Shiraishi Calcium Kaisha, Ltd.)

Inorganic filler 2: calcium carbonate (Brilliant-1500, manufactured by Shiraishi Calcium Kaisha, Ltd.)

Inorganic filler 3: calcium carbonate (Wham P-30, manufactured by Shiraishi Calcium Kaisha, Ltd.)

Inorganic filler 4: talc (Crown Talc PP, manufactured by Shiraishi Calcium Kaisha, Ltd.)

Inorganic filler 5: magnesium oxide (KYOWAMAG 150, manufactured by Kyowa Chemical Industry Co., Ltd.)

Inorganic filler 6: magnesium oxide (KYOWAMAG MF30, manufactured by Kyowa Chemical Industry Co., Ltd.)

Inorganic filler 7: glass beads (GL-BS, manufactured by Potters-Ballotini Co., Ltd.)

Inorganic filler 8: aluminum oxide (manufactured by Wako Pure Chemical Industries, Ltd.)

Antioxidant: Irganox 1010, manufactured by BASF Corporation.

TABLE 1

| | | Exam- | Exam- | Exam- | Exam- | Exam- | Exam- | Exam- | Exam- | Exam- | Exam- |
|---|---|---|---|---|---|---|---|---|---|---|---|
| | | ple 1 | ple 2 | ple 3 | ple 4 | ple 5 | ple 6 | ple 7 | ple 8 | ple 9 | ple 10 |
| POM resin | | 100 | 100 | 100 | 100 | 100 | 100 | 100 | 100 | 100 | 100 |
| Lubricant 1 | Ethylene-propylene | 1 | 2 | — | 1 | 1 | 1 | 1 | 1 | 1 | 1 |
| | copolymer | | | | | | | | | | |
| Lubricant 2 | Dimethylpolysiloxane | — | — | 1 | — | — | — | — | — | — | — |
| Inorganic filler 1 | Calcium carbonate | 0.5 | 0.5 | 0.5 | — | — | — | — | — | — | — |
| Inorganic filler 2 | Calcium carbonate | — | — | — | 0.5 | — | — | — | — | — | — |
| Inorganic filler 3 | Calcium carbonate | — | — | — | — | 0.5 | — | — | — | — | — |
| Inorganic filler 4 | Talc | — | — | — | — | — | 0.5 | — | — | — | — |
| Inorganic filler 5 | Magnesium oxide | — | — | — | — | — | — | 0.5 | — | — | — |
| Inorganic filler 6 | Magnesium oxide | — | — | — | — | — | — | — | 0.5 | — | — |
| Inorganic filler 7 | Glass beads | — | — | — | — | — | — | — | — | 0.5 | — |
| Inorganic filler 8 | Aluminum oxide | — | — | — | — | — | — | — | — | — | 0.5 |
| Antioxidant | Hindered phenol system | 0.21 | 0.21 | 0.21 | 0.21 | 0.21 | 0.21 | 0.21 | 0.21 | 0.21 | 0.21 |
| Dust-resistant | Squeak noise (%) | 37 | 0 | 72 | 3 | 4 | 11 | 45 | 0 | 0 | 22 |
| slidability | Friction and wear | 0.35 | 0.37 | 0.34 | 0.34 | 0.31 | 0.31 | 0.35 | 0.30 | 0.28 | 0.36 |
| | resistance: | | | | | | | | | | |
| | Coefficient of | | | | | | | | | | |
| | dynamic friction (—) | | | | | | | | | | |

TABLE 2

| | | Comparative | Comparative | Comparative | Comparative | Comparative |
|---|---|---|---|---|---|---|
| | | Example 1 | Example 2 | Example 3 | Example 4 | Example 5 |
| POM resin | | 100 | 100 | 100 | 100 | 100 |
| Lubricant 1 | Ethylene-propylene copolymer | — | — | 1 | 0.3 | — |
| Lubricant 3 | Paraffin oil | — | — | — | — | 1 |
| Inorganic filler 1 | Calcium carbonate | — | 0.5 | — | 0.5 | 0.5 |
| Antioxidant | Hindered phenol system | 0.21 | 0.21 | 0.21 | 0.21 | 0.21 |
| | Squeak noise (%) | 100 | 100 | 100 | 100 | 100 |
| Dust-resistant | Friction and wear resistance: | 0.39 | 0.41 | 0.37 | 0.40 | 0.41 |
| slidability | Coefficient of dynamic friction (—) | | | | | |

### <Evaluations>

Using the obtained resin composition pellets, hollow circular cylindrical test pieces were produced by injection molding (mold temperature: 80° C., cylinder temperature: 200° C.), and the evaluation tests described below were performed. In each test, in order to generate an environment in which dust and moisture existed, a dusty water prepared by dispersing ISO test dust 12103-1 A4 in pure water at a concentration of 2.5% by mass was applied to the sliding surface.

### [Dust-Resistant Slidability]

In order to evaluate the dust-resistant slidability, evaluations of squeak noises and the friction and wear resistance (coefficient of dynamic friction) were performed. Details regarding the test conditions are described below.

### (Test Conditions)

Test device: thrust-type friction and wear tester EFM-III-E, manufactured by Orientec Co., Ltd.

Surface pressure: 1.0 MPa (load 200 N)

Environment: 23° C., 50% RH

Linear speed: 10 mm/sec

Test duration: 3 hours (dusty water was applied, and after sliding for 2 hours, dusty water was reapplied, and sliding was continued for a further 1 hour)

Opposing material: polyethylene-coated flat sheet

### (Evaluation Items)

(1) Squeak noise (%): for the final 1 hour of the test, the percentage of time during which squeak noises occurred (%) was recorded.

(2) Coefficient of dynamic friction (−): calculated from the value for the frictional force detected with a load cell. The average value for the final 1 hour of the test was recorded.

Based on Table 1 and Table 2, it is evident that each example exhibited good friction and wear resistance, and displayed a reduced level of squeak noise. In other words, it is evident that a member having excellent dust-resistant slidability was able to be obtained in each of the examples. In contrast, none of the comparative examples was able to achieve favorable results for both the squeak noise evaluation and the friction and wear resistance evaluation.

In particular, by comparing all of the examples with Comparative Examples 2 and 3, it is evident that favorable evaluation results could not be achieved by using only one of the lubricant and the inorganic filler. Further, by comparing all of the examples and Comparative Example 4, it is evident that even when both a lubricant and an inorganic filler are included, favorable evaluation results may not necessarily be obtainable, depending on the amount of each component.

1. A method for producing a dust-resistant sliding member, the method comprising:
a step of preparing a resin composition consisting essentially of 0.5 to 5.0 parts by mass of a lubricant that is liquid at 25° C. and is composed of at least one material selected from the group consisting of ethylene/α-olefin copolymers, poly-α-olefins and silicones, and 0.1 to 30 parts by mass of an inorganic filler, per 100 parts by mass of a polyacetal resin, wherein the inorganic filler consists of at least one material selected from the group consisting of calcium carbonate, magnesium oxide, aluminum oxide, talc and glass beads, and
a step of molding the resin composition into a prescribed shape.

2. The method for producing a dust-resistant sliding member according to claim 1, wherein the lubricant is an ethylene-propylene copolymer.

3. (canceled)

4. The method for producing a dust-resistant sliding member according to claim 2, wherein the inorganic filler is at least one material selected from the group consisting of calcium carbonate, magnesium oxide, aluminum oxide, talc and glass beads.

5. A dust-resistant sliding member, produced using the method for producing-a dust-resistant sliding member according to claim 1.

6. A window regulator carrier plate, produced using the method for producing a dust-resistant sliding member according to claim 1.

7. A method for realizing dust-resistant slidability for a member comprising contacting the member so as to slidably guide a glass, wherein the member consists essentially of a polyacetal resin composition comprising 0.5 to 5.0 parts by mass of a lubricant that is liquid at 25° C. and is composed of at least one material selected from the group consisting of ethylene/α-olefin copolymers, poly-α-olefins and silicones, and 0.1 to 30 parts by mass of an inorganic filler, per 100 parts by mass of a polyacetal resin,
wherein the inorganic filler consists of at least one material selected from the group consisting of calcium carbonate, magnesium oxide, aluminum oxide, talc and glass beads.

8. The method for realizing dust-resistant slidability for a member according to claim 7, wherein the lubricant is an ethylene-propylene copolymer.

9. (canceled)

10. The method for realizing dust-resistant slidability for a member according to claim 8, wherein the inorganic filler is at least one material selected from the group consisting of calcium carbonate, magnesium oxide, aluminum oxide, talc and glass beads.
